(19) United States
(12) Patent Application Publication
(10) Pub. No.: US 2025/0386101 A1
(43) Pub. Date: Dec. 18, 2025

(54) ANTI-SHAKE COMPENSATION METHOD, CAMERA DEVICE, AND COMPUTER-READABLE STORAGE MEDIUM

(71) Applicant: AAC Acoustic Technologies (Shanghai) Co., Ltd., Shanghai (CN)

(72) Inventor: Xiu Wu, Shanghai (CN)

(21) Appl. No.: 18/988,966

(22) Filed: Dec. 20, 2024

Related U.S. Application Data
(63) Continuation of application No. PCT/CN2024/098597, filed on Jun. 12, 2024.

(51) Int. Cl. H04N 23/68

(52) U.S. Cl. CPC H04N 23/687

(57) ABSTRACT

An anti-shake compensation method, a camera device, and a computer-readable storage medium relate to a field of optical image stabilization are provided. The anti-shake compensation method includes determining, according to sensor data of an actuator in a camera device, whether a lens module where the actuator is located is affected by gravity; when the lens module where the actuator is located is affected by the gravity, determining an anti-shake compensation amount according to a gravity compensation coefficient of the camera device; and performing anti-shake compensation on the lens module where the actuator is located in the camera device according to the anti-shake compensation amount. The anti-shake compensation amount overcomes an influence of the gravity. The influence of the gravity in an anti-shake process is considered, so as to improve an anti-shake capability of the camera device and further improve stability of an image.

### TECHNICAL FIELD

The present disclosure relates to a field of optical image stabilization, and in particular to an anti-shake compensation method, a camera device, and a computer-readable storage medium.

### BACKGROUND

With rapid development of smartphones and photography and video technology, lens-type optical image stabilization (OIS) technology becomes a key to improving image quality. Conventional OIS systems perform well on lenses that are relatively light. However, in recent years, in terms of mobile terminal imaging, in order to further improve image quality, more and more lenses are made from heavier glass materials than that of conventional lenses, which greatly increases a weight of the lenses. The weight of the lenses makes an impact of gravity on the conventional OIS systems more obvious.

The inventor found that a current proportion-integration-differentiation (PID) control algorithm has made achievements in positioning accuracy of the lenses, but has limitations in dealing with an initial impact caused by the gravity and maintaining long-term stability. Influence of the gravity causes a position of a lens module in a camera device to shift, which in turn affects an output and a driving current of a closed-loop PID control and reduces stability of images.

In a conventional OIS control system, a difference between a target position and a feedback position of the lens module is directly used as an input of the PID control algorithm, and a value of the driving current is adjusted by the PID control algorithm to precisely control a position of a voice coil motor (VCM). When the lens module is affected by the gravity, the lens module generally deviates from a certain position, and such deviation is difficult to compensate instantly by a given target value. In the conventional OIS control system that uses the VCM for optical image stabilization, the lens module has attitude differences in different attitudes due to the influence of the gravity. During an image stabilization process, a relative position of an actuator thereof is difficult to position in a center position of the lens module due to the influence of the gravity, which further damages a maximum image stabilization capability of the conventional OIS control system. As a result, image stabilization performance of the camera device where the conventional OIS control system is installed is reduced, and image stability is low.

### SUMMARY

A purpose of the present disclosure is to provide an anti-shake compensation method, so that a camera device after anti-shake compensation is able to overcome a problem of position deviation of a lens module thereof caused by gravity, which improves anti-shake performance of the camera device and improves stability of an image taken by the camera device.

To achieve the above purpose, the present disclosure provides an anti-shake compensation method. The anti-shake compensation method comprises steps:
determining, according to sensor data of an actuator in a camera device, whether a lens module where the actuator is located is affected by gravity;
when the lens module where the actuator is located is affected by the gravity, determining an anti-shake compensation amount according to a gravity compensation coefficient of the camera device; and
performing anti-shake compensation on the lens module where the actuator is located in the camera device according to the anti-shake compensation amount.

In one optional embodiment, a step of determining the gravity compensation coefficient of the camera device comprises steps:
controlling the lens module in the camera device to rotate according to a predetermined angle;
acquiring displacement sensor data and attitude sensor data of the actuator during rotation; and
determining the gravity compensation coefficient according to the displacement sensor data and the attitude sensor data.

In one optional embodiment, the step of determining the gravity compensation coefficient according to the displacement sensor data and the attitude sensor data comprises:
fitting the displacement sensor data and the attitude sensor data to obtain the gravity compensation coefficient.

In one optional embodiment, the step of determining the anti-shake compensation amount according to the gravity compensation coefficient of the camera device comprises:
correcting the sensor data of the actuator in the camera device according to the gravity compensation coefficient to obtain target sensor data; and
determine the anti-shake compensation amount according to the target sensor data.

In one optional embodiment, the step of determining, according to sensor data of the actuator in the camera device, whether the lens module where the actuator is located is affected by the gravity comprises:
monitoring the sensor data of the actuator in the camera device in real time;
when at least one of the sensor data is greater than a predetermined gravity-affected threshold of a sensor type corresponding to the sensor data, determining that the lens module where the actuator is located is affected by the gravity; and
when none of the sensor data is greater than the predetermined gravity-affected threshold of the sensor type corresponding to the sensor data, determining that the lens module where the actuator is located is not affected by the gravity.

In one optional embodiment, the sensor data comprises attitude sensor data and/or displacement sensor data.

In one optional embodiment, the displacement sensor data of the actuator comprises a displacement of the actuator in a horizontal direction and a displacement of the actuator in a vertical direction.

In one optional embodiment, in the present angle is not less than 90 degrees.

The present disclosure further provides a camera device. The camera device comprises at least one processor and a memory in communication with the at least one processor. The memory stores instructions executable by the at least one processor, and when the instructions are executed by the at least one processor, the at least one processor executes the anti-shake compensation method mentioned above.

The present disclosure further provides a computer-readable storage medium. The computer-readable storage medium comprises computer programs stored therein. The computer programs are executed by at least one processor to implement the anti-shake compensation method mentioned above.

In the embodiments of the present disclosure, whether the lens module where the actuator is located is affected by the gravity is determined, when the lens module is affected by the gravity, the anti-shake compensation amount is determined according to the gravity compensation coefficient of the camera device to perform anti-shake compensation for the camera device, so that the anti-shake compensation amount is able to overcome an influence of the gravity. The present disclosure takes into account the influence of the gravity in an anti-shake process, so as to improve an anti-shake capability of the camera device and further improve stability of the image.

### BRIEF DESCRIPTION OF DRAWINGS

One or more embodiments are exemplarily described by pictures in corresponding drawings, and these exemplary descriptions do not constitute limitations on the embodiments.

FIG. 1 is a flow chart of an anti-shake compensation method according to a first embodiment of the present disclosure.

FIG. 2 is a flow chart of the anti-shake compensation method according to a second embodiment of the present disclosure.

FIG. 3 is a flow chart of the anti-shake compensation method according to a third embodiment of the present disclosure.

FIG. 4 is a flow chart of the anti-shake compensation method according to a fourth embodiment of the present disclosure.

FIG. 5 is a schematic structural diagram of a camera device according to one embodiment of the present disclosure.

### DETAILED DESCRIPTION

To make objectives, technical solutions, and advantages of embodiments of the present disclosure clearer, the following describes the embodiments of the present disclosure in detail with reference to the accompanying drawings. However, it should be understood by those of ordinary skill in the art that in various embodiments of the present disclosure, many technical details are set forth in order to make a reader better understand the present disclosure. However, even without these technical details and various changes and modifications based on the following embodiments, technical solutions claimed in the present disclosure may allow to be implemented. The following division of the embodiments is for convenience of description, and should not constitute any limitation on the specific implementations of the present disclosure, and the various embodiments may be combined with each other without contradiction.

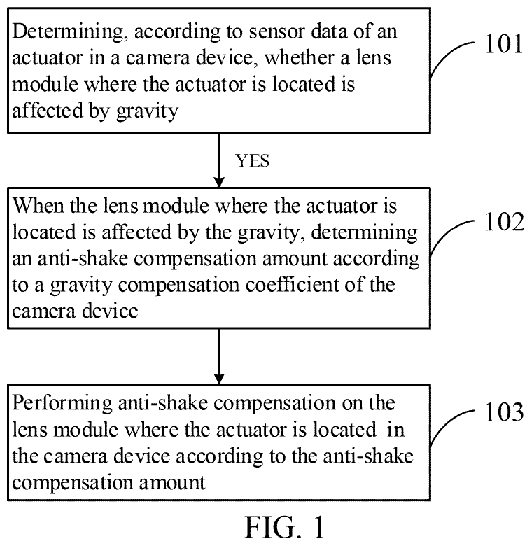

The present disclosure provides an anti-shake compensation method to improve transient and steady-state performance of optical image stabilization (OIS) when using a proportion-integration-differentiation (PID) control algorithm to control a heavy lens. FIG. 1 is a flow chart of an anti-shake compensation method according to a first embodiment of the present disclosure. As shown in FIG. 1, in one embodiment, the anti-shake compensation method comprises steps 101-103.

The step 101 comprises determining, according to sensor data of an actuator in a camera device, whether a lens module where the actuator is located is affected by gravity.

In an OIS system, the actuator in the camera device generally refers to a moving assembly inside the lens module. The moving assembly is configured to compensate for image blur caused by shaking or movement f the camera device. The moving assembly actively moves to keep a captured image stable when the shaking of the camera device is detected. By accurately moving the moving assembly, the OIS system reduces an impact of the shaking of the camera device on image quality. For example, the OIS system in a mobile phone or a camera is able to detect an angle change and a direction change of the camera through a gyroscope, and then a lens thereof or a sensor thereof is moved through electronic and mechanical means to compensate for the shaking, making photos and videos taken clearer and reducing the impact of photo blur and video shaking.

Generally, sensors of the actuator comprises an attitude sensor, a displacement sensor, etc. Correspondingly, the sensor data of the actuator comprises attitude sensor data, displacement sensor data, etc.

The gravity is a gravitational field and the gravity may cause the camera device to rotate. Therefore, through the sensor data of the actuator in the camera device, an influence of the gravity is digitized to determine whether the lens module where the actuator is located is affected by the gravity.

The step 102 comprises when the lens module where the actuator is located is affected by the gravity, determining an anti-shake compensation amount according to a gravity compensation coefficient of the camera device.

When it is determined that the lens module where the actuator is located is affected by the gravity, the anti-shake compensation amount after gravity compensation is determined based on a pre-calculated gravity compensation coefficient (i.e., the gravity compensation coefficient) of the camera device and the real-time sensor data (i.e., the sensor data) of the sensors built in the camera device. The sensors of the camera device comprise an accelerometer, a gyroscope, etc.

In the embodiment of the present disclosure, each of different types of camera devices has a corresponds gravity compensation coefficient.

When it is determined that the lens module where the actuator is located is not affected by the gravity, the real-time sensor data of the sensors built in the camera device is calculated according to a conventional PID algorithm to obtain a conventional anti-shake compensation amount.

The step 103 comprises performing anti-shake compensation on the lens module where the actuator is located in the camera device according to the anti-shake compensation amount.

After the anti-shake compensation amount is calculated, the camera device converts the anti-shake compensation amount into a control instruction for the actuator. The control instruction is transmitted to the actuator disposed in the lens module to adjust a position or a direction of the lens module to offset an impact of movement of the camera device.

During a shooting process, the camera device needs to continuously obtain the sensor data, calculate the anti-shake compensation amount, and adjust the position of the actuator in real time to maintain stability and clarity of the image. A compensation process continues until the shooting is completed.

In the anti-shake compensation method of the present disclosure, whether the lens module where the actuator is located is affected by the gravity is determined, when the lens module is affected by the gravity, the anti-shake compensation amount is determined according to the gravity compensation coefficient of the camera device to perform anti-shake compensation for the camera device, so that the anti-shake compensation amount is able to overcome the influence of the gravity. The present disclosure takes into account the influence of the gravity in the anti-shake process, so as to improve an anti-shake capability of the camera device and further improve stability of the image

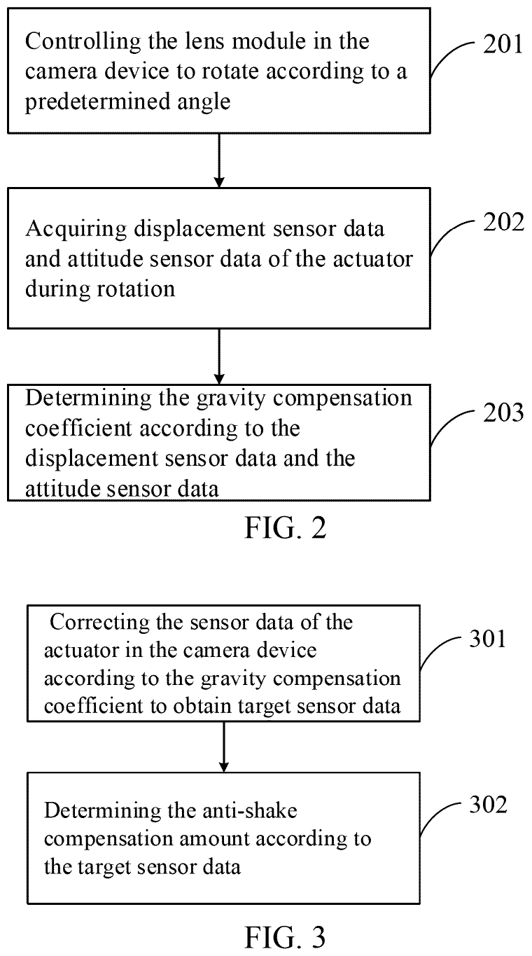

Based on the anti-shake compensation method shown in FIG. 1, one embodiment of the present disclosure further provides a second embodiment of the anti-shake compensation method. Specifically, FIG. 2 is a flow chart of the anti-shake compensation method according to a second embodiment of the present disclosure. As shown in FIG. 2, a step of determining the gravity compensation coefficient of the camera device in the step 102 specifically comprises following steps 201-203.

The step 201 comprises controlling the lens module in the camera device to rotate according to a predetermined angle.

Specifically, a motor in the camera device is controlled to rotate the lens module in the camera device according to the predetermined angle.

The predetermined angle is not less than 90 degrees, so that the lens module is at least rotated to a horizontal direction or a vertical direction. Of course, the predetermined angle may be not less than 180 degrees, so that the lens module is at least rotated to the horizontal direction and the vertical direction.

When the predetermined angle is 90 degrees, the lens module is controlled to rotate from the horizontal direction to the vertical direction, or from the vertical direction to the horizontal direction.

The larger the predetermined angle, the more horizontal displacement and vertical displacement are made, and the more accurate the gravity compensation coefficient is.

The step 202 comprises acquiring displacement sensor data and attitude sensor data of the actuator during rotation.

The motor is calibrated, and the displacement sensor data and the attitude sensor data of the actuator during a rotation process are recorded.

The displacement sensor data of the actuator comprises an actual displacement of the actuator in the horizontal direction and an actual displacement of the actuator in the vertical direction.

The attitude sensor data of the actuator comprises a pitch angle relative to a horizontal plane, a roll angle relative to the horizontal plane, a yaw angle relative to the horizontal plane, and other information of the actuator.

During the rotation process, the displacement sensor data of the actuator and the attitude sensor data of the actuator are acquired according to a predetermined time interval.

In the embodiment of the present disclosure, an amount of the displacement sensor data of the actuator during the rotation process is not less than five, and an amount of the attitude sensor data is not less than five, so as to ensure the accuracy of the gravity compensation coefficient.

The step 203 comprises determining the gravity compensation coefficient according to the displacement sensor data and the attitude sensor data.

The gravity affects a relationship between the position/the displacement sensor data and the attitude sensor data of the actuator in the horizontal direction or the vertical direction. It is mainly because that the gravity applies additional force to the actuator during the rotation process of the lens module, causing the relationship between the displacement sensor data and the attitude sensor data to change. When the lens module rotates from the horizontal direction to the vertical direction, the gravity acts in the vertical direction, causing the actuator to be subjected to an additional downward force. The additional downward force affects a change speed of the displacement sensor data. As a result, the displacement of the actuator in the horizontal direction or the vertical direction is affected by the gravity to change. At the same time, the gravity also affects the pitch angle in the attitude sensor data. During the rotation process of the lens module, the gravity causes the lens module to rotate around a horizontal axis, thereby changing a value of the pitch angle. The change in the value of the pitch angle also affects the relationship between the attitude sensor data and the displacement sensor data. Therefore, the gravity causes the relationship between the displacement sensor data and the attitude sensor data to change by applying the additional force to the actuator.

The gravity compensation coefficient represents the relationship between the displacement sensor data and the attitude sensor data under the influence of the gravity. The gravity compensation coefficient may be one value, two values, or more values.

In the anti-shake compensation method provided in the embodiment of the present disclosure, the motor is calibrated to obtain the relationship between the displacement sensor data and the attitude sensor data of the actuator under the influence of the gravity. Subsequently, the relationship between the sensor data under the influence of the gravity is applied to the conventional anti-shake compensation amount calculated by the conventional PID control algorithm that does not consider the influence of the gravity, so as to obtain the anti-shake compensation amount that is able to overcome the influence of the gravity.

Based on the anti-shake compensation method shown in FIG. 2, the present disclosure further provides the anti-shake compensation method. Specifically, the step 203 of determining the gravity compensation coefficient according to the displacement sensor data and the attitude sensor data comprises fitting the displacement sensor data and the attitude sensor data to obtain the gravity compensation coefficient.

A model is established to describe the relationship between the displacement sensor data and the attitude sensor data. Taking into account an effect of the gravity, the model may be a linear model or a nonlinear model to fit the relationship, and the model comprises the displacement sensor data, the attitude sensor data, and the gravity compensation coefficient.

A fitting algorithm, such as a least squares method, a nonlinear least squares method, etc. is adopted to fit model parameters. The model parameters reflect the relationship between the displacement sensor data and the attitude sensor data under the influence of the gravity.

A validation data set can also be used to evaluate the performance of the model on new data to ensure that the model can accurately characterize the relationship between the displacement sensor data and the attitude sensor data.

The gravity compensation coefficient is written into a register of an anti-shake control system for compensating an anti-shake target position during the anti-shake process.

In the anti-shake compensation method provided in the embodiment of the present disclosure, the relationship between the displacement sensor data and the attitude sensor data under the influence of the gravity is obtained by fitting.

Based on the anti-shake compensation method shown in FIG. 1, the present disclosure further provides a third embodiment of the anti-shake compensation method. Specifically, FIG. 3 is a flow chart of the anti-shake compensation method according to the third embodiment of the present disclosure. As shown in FIG. 3, the step 102 of determining the anti-shake compensation amount according to the gravity compensation coefficient of the camera device comprises steps 301-302.

The step 301 comprises correcting the sensor data of the actuator in the camera device according to the gravity compensation coefficient to obtain target sensor data.

The target sensor data is the sensor data under the influence of the gravity.

Optionally, the attitude sensor data under the influence of the gravity is determined according to the gravity compensation coefficient and the displacement sensor data in the sensor data of the actuator in the camera device. Then, the attitude sensor data and the displacement sensor data under the influence of the gravity are served as the target sensor data.

Optionally, the displacement sensor data under the influence of the gravity is determined according to the gravity compensation coefficient and the attitude sensor data in the sensor data of the actuator in the camera device. Then, the displacement sensor data and the attitude sensor data under the influence of the gravity are served as the target sensor data.

Optionally, the attitude sensor data and the displacement sensor data in the sensor data of the actuator in the camera device are adjusted simultaneously according to the gravity compensation coefficient to obtain the displacement sensor data under the influence of the gravity and the displacement sensor data under the influence of the gravity as the target sensor data.

The step 302 comprises determining the anti-shake compensation amount according to the target sensor data.

Specifically, a final anti-shake compensation amount is determined according to the target sensor data and the PID control algorithm.

The final anti-shake compensation amount is the anti-shake compensation amount that takes into account the influence of the gravity.

In the anti-shake compensation method provided in the embodiment of the present disclosure, the sensor data is corrected by the gravity compensation coefficient, so that the final anti-shake compensation amount is the anti-shake compensation amount that takes into account the influence of the gravity, thereby improving the anti- shake capability of the camera device.

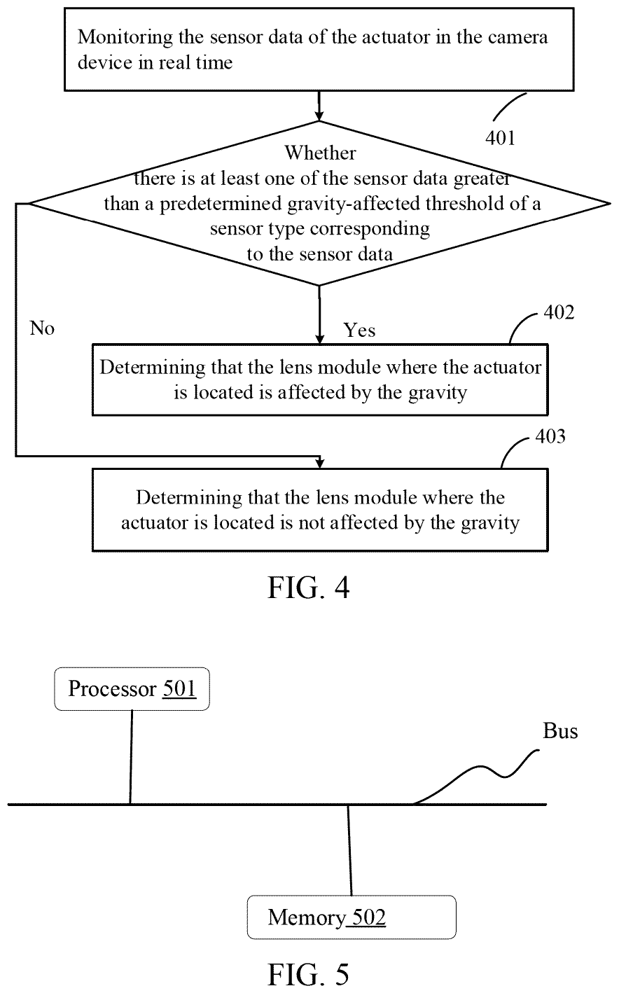

Based on the anti-shake compensation method shown in FIG. 1, the present disclosure further provides a fourth embodiment of the anti-shake compensation method. Specifically, FIG. 4 is a flow chart of the anti-shake compensation method according to the fourth embodiment of the present disclosure. As shown in FIG. 4, the step 101 of determining, according to sensor data of the actuator in the camera device, whether the lens module where the actuator is located is affected by the gravity comprises steps 401-403.

The step 401 comprises monitoring the sensor data of the actuator in the camera device in real time.

The sensor data comprises the attitude sensor data and/or the displacement sensor data.

The step 402 comprises when at least one of the sensor data is greater than a predetermined gravity-affected threshold of a sensor type corresponding to the sensor data, determining that the lens module where the actuator is located is affected by the gravity.

When the sensor data comprises the attitude sensor data, if at least one of the attitude sensor data is greater than a predetermined gravity-affected threshold corresponding to the attitude sensor, it is determined that the lens module where the actuator is located is affected by the gravity.

When the sensor data comprises displacement sensor data, if at least one of the displacement sensor data is greater than a predetermined gravity-affected threshold corresponding to the displacement sensor, it is determined that the lens module where the actuator is located is affected by the gravity.

When the sensor data comprises the attitude sensor data and the displacement sensor data, if at least one of the sensor data is greater than the predetermined gravity-affected threshold of the sensor type corresponding to the sensor data, it is determined that the lens module where the actuator is located is affected by the gravity. For example, when one of the attitude sensor data in the sensor data is greater than the predetermined gravity-affected threshold corresponding to the attitude sensor, it is determined that the lens module where the actuator is located is affected by the gravity. Alternatively, when one of the displacement sensor data in the sensor data is greater than the predetermined gravity-affected threshold corresponding to the displacement sensor, it is determined that the lens module where the actuator is located is affected by the gravity.

The predetermined gravity-affected threshold of the sensor type is determined based on experience, and then the predetermined gravity-affected threshold is continuously updated through the stability of the image captured by the camera device, so that the image is more stable.

The step 403 comprises when none of the sensor data is greater than the predetermined gravity-affected threshold of the sensor type corresponding to the sensor data, determining that the lens module where the actuator is located is not affected by the gravity.

Of course, whether the lens module where the actuator is located is affected by the gravity is determined through other sensor data, which is not specifically limited in the embodiment of the present disclosure.

In the anti-shake compensation method provided by the embodiment of the present disclosure, by monitoring the sensor data of the actuator in the camera device in real time, whether the lens module where the actuator is located is affected by the gravity is determined in real time, thereby achieving real-time gravity anti-shake.

In one embodiment, when sensed attitude sensor data (code) is greater than a predetermined threshold, the OIS system starts anti-shake displacement (the digital part is expressed in code) compensation and corrects an anti-shake target. A specific compensation algorithm is implemented through polynomial calculation. Conversely, when the sensed attitude sensor data (code) is not greater than the predetermined threshold, the anti-shake displacement obtained by the gyroscope (Gyro) is directly accepted for compensation.

It should be noted that the compensation for the influence of the gravity is related to an angle of the lens module, so it is necessary to increase sense of the attitude. In an OIS anti-shake system of a mobile phone, the influence of the gravity on the lens module is obtained from a sensed value of an initial Hall sensor. Then, when gravity affects the lens module, the target sensor data under control needs to compensate the sensor data generated by the influence of the gravity first, and then compensated target sensor data is served as a real target sensor data under control to realize OIS anti-shake compensation.

In an OIS anti-shake algorithm, a shaking speed is sensed by the gyroscope, and then a displacement thereof is obtained through digital processing. Furthermore, the displacement needs to be compensated by the PID control algorithm. In order to cooperate with the PID control algorithm, two methods are provided. A first method is to collect feedback movement positions of a voice coil motor (VCM) through the Hall sensor to obtain digital sensor data and directly feed the digital sensor data back into the PID control algorithm. In this way, the anti-shake target position needs to be converted into the digital sensor data and then being input into the PID control algorithm. The second method is to collect the feedback movement positions of the VCM through the Hall sensor to obtain the digital sensor data and convert the digital sensor data into a displacement concept and then feed the displacement concept back into the PID control algorithm. In this way, the anti-shake target position is directly input into the PID control algorithm.

It is noted that a driving current of the VCM may be increased to increase anti-shake stability and a response speed, which alleviates the influence of the gravity, but problems caused by the gravity are still unavoidable.

The above steps of the present disclosure are divided only for a purpose of clear description. When implementing, the steps may be combined into one step or at least part of the steps may be divided and decomposed into sub-steps. As long as the steps comprise the same logical relationship, the steps are within the protection scope of the present disclosure. Technical solutions adding insignificant modifications to the algorithm or process or introducing insignificant designs without changing the core design of the algorithm and process, should fall within the protection scope of the present disclosure.

The present disclosure further provides a camera device. FIG. 5 is a schematic structural diagram of a camera device according to one embodiment of the present disclosure. As shown in FIG. 5, the camera device comprises at least one processor 501 and a memory 502 in communication with the at least one processor 501. The memory 501 stores instructions executable by the at least one processor 501, and when the instructions are executed by the at least one processor 501, the at least one processor 501 executes the anti-shake compensation method mentioned above.

The memory 502 and the at least one processor 501 are connected by a bus, which may comprise any number of interconnected buses and bridges, and the bus connects circuits of at least one processors 501 and circuit of the memory 502 together.

The at least one processor 501 is responsible for managing the bus and general processing. The at least one processor 501 has various functions. The memory 502 is configured to store data executed by the at least one processor 501.

The present disclosure further provides a computer-readable storage medium. The computer-readable storage medium comprises computer programs stored therein. The computer programs are executed by at least one processor to implement the anti- shake compensation method mentioned above.

Those skilled in the art can understand that all or part of the steps in the above-mentioned embodiments may be completed by instructing relevant hardware through the programs. The programs are stored in the computer-readable storage medium and comprises instructions for a device (such as a single-chip microcomputer, chip, etc.) or the at least one processor to perform all or part of the steps of the methods described in various embodiments of the present disclosure. The computer-readable storage medium may be a USB flash drive, a mobile hard drive, a read-only memory (ROM), a random access memory (RAM), disk, optical disk, or other medium that is able to store program codes.

Those skilled in the art can understand that the embodiments are specific embodiments of the present disclosure, and in actual applications, various changes can be made to them in form and details without departing from the spirit and scope of the present disclosure.

What is claimed is:

1. An anti-shake compensation method, comprising steps:
determining, according to sensor data of an actuator in a camera device, whether a lens module where the actuator is located is affected by gravity;
when the lens module where the actuator is located is affected by the gravity, determining an anti-shake compensation amount according to a gravity compensation coefficient of the camera device; and
performing anti-shake compensation on the lens module where the actuator is located in the camera device according to the anti-shake compensation amount.

2. The anti-shake compensation method according to claim 1, wherein a step of determining the gravity compensation coefficient of the camera device comprises steps:
controlling the lens module in the camera device to rotate according to a predetermined angle;
acquiring displacement sensor data and attitude sensor data of the actuator during rotation; and
determining the gravity compensation coefficient according to the displacement sensor data and the attitude sensor data.

3. The anti-shake compensation method according to claim 2, wherein the step of determining the gravity compensation coefficient according to the displacement sensor data and the attitude sensor data comprises:
fitting the displacement sensor data and the attitude sensor data to obtain the gravity compensation coefficient.

4. The anti-shake compensation method according to claim 1, wherein the step of determining the anti-shake compensation amount according to the gravity compensation coefficient of the camera device comprises:
correcting the sensor data of the actuator in the camera device according to the gravity compensation coefficient to obtain target sensor data; and
determining the anti-shake compensation amount according to the target sensor data.

5. The anti-shake compensation method according to claim 1, wherein the step of determining, according to sensor data of the actuator in the camera device, whether the lens module where the actuator is located is affected by the gravity comprises:
monitoring the sensor data of the actuator in the camera device in real time;
when at least one of the sensor data is greater than a predetermined gravity-affected threshold of a sensor type corresponding to the sensor data, determining that the lens module where the actuator is located is affected by the gravity; and
when none of the sensor data is greater than the predetermined gravity-affected threshold of the sensor type corresponding to the sensor data, determining that the lens module where the actuator is located is not affected by the gravity.

6. The anti-shake compensation method according to claim 1, wherein the sensor data comprises attitude sensor data and/or displacement sensor data.

7. The anti-shake compensation method according to claim 2, wherein the displacement sensor data of the actuator comprises a displacement of the actuator in a horizontal direction and a displacement of the actuator in a vertical direction.

8. The anti-shake compensation method according to claim 2, wherein the present angle is not less than 90 degrees.

9. A camera device, comprising:
at least one processor; and,
a memory in communication with the at least one processor;
wherein the memory stores instructions executable by the at least one processor, and when the instructions are executed by the at least one processor, the at least one processor executes the anti-shake compensation method according to claim 1.

10. A computer-readable storage medium, comprising computer programs stored therein;
wherein the computer programs are executed by at least one processor to implement the anti-shake compensation method according to claim 1.
